(19) United States
(12) Patent Application Publication
(10) Pub. No.: US 2026/0103181 A1
(43) Pub. Date: Apr. 16, 2026

(54) HYBRID ELECTRIC VEHICLE

(71) Applicant: TOYOTA JIDOSHA KABUSHIKI KAISHA, Toyota-shi (JP)

(72) Inventors: Masato YOSHIKAWA, Toyota-shi (JP); Naoki HAYASHIMA, Toyota-shi (JP); Yuji MATSUMURA, Toyota-shi (JP); Shogo KAWAI, Toyota-shi (JP)

(73) Assignee: TOYOTA JIDOSHA KABUSHIKI KAISHA, Toyota-shi (JP)

(21) Appl. No.: 19/219,213

(22) Filed: May 27, 2025

(30) Foreign Application Priority Data
Oct. 2, 2024 (JP) 2024-173843

(51) Int. Cl. B60W 20/15; B60W 10/02; B60W 10/06

(52) U.S. Cl. CPC B60W 20/15; B60W 10/06; B60W 10/026; B60W 2510/0233; B60W 2510/0642; B60W 2520/04; B60W 2710/065; B60W 2710/0661; B60W 2710/248

(57) ABSTRACT

A hybrid electric vehicle includes: an engine; a motor; a torque converter; an automatic transmission; a battery; and a control device. The control device includes: a determination unit configured to determine whether the engine is in a driven state, the hybrid electric vehicle is in a stopped state, the automatic transmission is in a D range, and the lock-up clutch is in a released state; a setting unit configured to, when affirmative determination is made by the determination unit, set a target idle speed that is a target rotation speed in an idle operation state of the engine to a higher value as requested charging power of the battery increases; and a control unit configured to, when the engine is in the idle operation state, control the engine to reduce an increase rate for increasing an engine speed toward the target idle speed as the engine speed increases.

### CROSS-REFERENCE TO RELATED APPLICATION

This application claims priority to Japanese Patent Application No. 2024-173843 filed on Oct. 2, 2024. The disclosure of the above-identified application, including the specification, drawings, and claims, is incorporated by reference herein in its entirety.

### BACKGROUND

### 1. Technical Field

The present disclosure relates to a hybrid electric vehicle.

### 2. Description of Related Art

There is a hybrid electric vehicle in which the target idle speed of an engine is set to a higher value in response to a battery charging request (see, for example, Japanese Unexamined Patent Application Publication No. 2024-078322 (JP 2024-078322 A)).

### SUMMARY

It is conceivable to set the target idle speed to a higher value as the requested charging power of the battery increases. When the target idle speed is increased, however, creep torque increases and the acceleration at the time of starting the vehicle increases, which may decrease the drivability.

An object of the present disclosure is to provide a hybrid electric vehicle in which a decrease in drivability is suppressed.

The above object can be achieved by a hybrid electric vehicle including:
an engine;
a motor provided on a power transmission path between the engine and a drive wheel and configured to generate electric power by receiving rotational power of the engine;
a torque converter provided on the power transmission path between the motor and the drive wheel and including a lock-up clutch;
an automatic transmission provided between the torque converter and the drive wheel;
a battery to be charged with generated electric power of the motor; and
a control device.

The control device includes:
a determination unit configured to determine whether the engine is in a driven state, the hybrid electric vehicle is in a stopped state, the automatic transmission is in a D range, and the lock-up clutch is in a released state;
a setting unit configured to, when affirmative determination is made by the determination unit, set a target idle speed that is a target rotation speed in an idle operation state of the engine to a higher value as requested charging power of the battery increases; and
a control unit configured to, when the engine is in the idle operation state, control the engine to reduce an increase rate for increasing an engine speed toward the target idle speed as the engine speed increases.

The setting unit may be configured to set the target idle speed stepwise to a higher value as the requested charging power of the battery increases, and the control unit may be configured to reduce the increase rate stepwise as the engine speed increases.

The setting unit may be configured to set the target idle speed to a first rotation speed when the requested charging power is less than a first threshold value, set the target idle speed to a second rotation speed higher than the first rotation speed when the requested charging power is equal to or more than the first threshold value and less than a second threshold value more than the first threshold value, and set the target idle speed to a third rotation speed higher than the second rotation speed when the requested charging power is equal to or more than the second threshold value.

The control unit may be configured to control the increase rate to a first rate when the target idle speed is set to the second rotation speed or the third rotation speed and the engine speed is less than the second rotation speed, and control the increase rate to a second rate less than the first rate when the target idle speed is set to the third rotation speed and the engine speed is equal to or more than the second rotation speed and less than the third rotation speed.

According to the present disclosure, it is possible to provide the hybrid electric vehicle in which the decrease in drivability is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a hybrid electric vehicle;

FIG. 2 is a flow chart illustrating idle speed control;

FIG. 3 is a timing chart illustrating idle speed control; and

FIG. 4 is a graph showing the relationship between the idle speed and the turbine torque.

### DETAILED DESCRIPTION OF EMBODIMENTS

### Schematic Configuration of Hybrid Electric Vehicle

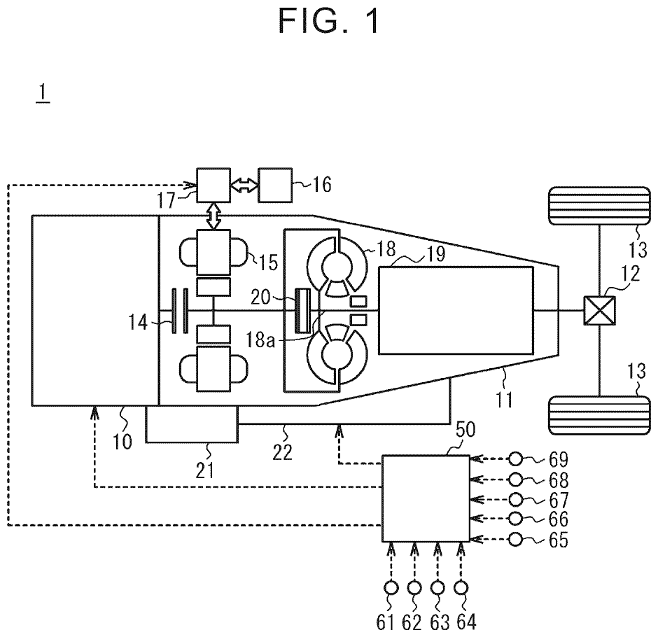

FIG. 1 is a schematic configuration diagram of a hybrid electric vehicle 1. Hybrid electric vehicle 1 is equipped with an engine 10 and a motor 15 as a driving power source. The engine 10 is a gasoline engine having a plurality of cylinders, but may also be a diesel engine. A transmission unit 11 is provided on a power transmission path from the engine 10 to the drive wheels 13. The transmission unit 11 and the left and right drive wheels 13 are drivingly coupled to each other via a differential gear 12.

The transmission unit 11 is provided with a K0 clutch 14 and a motor 15. The motor 15 is provided on a power transmission path from the engine 10 to the drive wheels 13.

K0 clutch 14 is provided between the engine 10 and the motor 15 in the power transmission path. K0 clutch 14 is engaged by receiving the hydraulic pressure and connects the power transmission between the engine 10 and the motor 15. K0 clutch 14 is released in response to the stoppage of the hydraulic pressure supply and shuts off the power transmission between the engine 10 and the motor 15. In addition, K0 clutch 14 is slipped from the beginning of the torque-transmission until it is fully engaged.

The motor 15 is connected to the battery 16 via an inverter 17. The battery 16 is a rechargeable secondary battery such as a nickel metal hydride battery or a lithium-ion battery. The motor 15 functions as a motor that generates a driving force of the vehicle in response to power supply from the battery 16. The motor 15 also functions as a generator that generates electric power to charge the battery 16 in response to power transmission from the engine 10 and the drive wheels 13. The electric power exchanged between the motor 15 and the battery 16 is adjusted by the inverter 17.

The transmission unit 11 is provided with a torque converter 18 and an automatic transmission 19. The torque converter 18 is a fluid coupling having a torque amplification function. The torque converter 18 is provided between the motor 15 and the drive wheels 13 on the power transmission path. The turbine shaft 18a of the torque converter 18 is connected to the input shaft of the automatic transmission 19. The turbine shaft 18a corresponds to the output shaft of the torque converter 18. The torque converter 18 is provided with a lock-up clutch (hereinafter referred to as a LU clutch) 20 which is engaged with the motor 15 by receiving the supply of the hydraulic pressure and directly connects the motor to the automatic transmission 19.

LU clutch 20 is engaged by receiving the hydraulic pressure and connects the power transmission between the motor 15 and the drive wheels 13. LU clutch 20 is released in response to the stoppage of the hydraulic pressure supplying. LU clutch 20 is also slipped from release to engagement.

The automatic transmission 19 is provided between the torque converter 18 and the drive wheels 13 on the power transmission path. The automatic transmission 19 is a stepped transmission and includes a plurality of hydraulic friction engagement elements and a planetary gear set. In the automatic transmission 19, a plurality of friction engagement elements are selectively engaged to switch between the P (parking) range, the R (reverse) range, the N (neutral) range, and the D (drive) range.

The transmission unit 11 is further provided with an oil pump 21 and a hydraulic control mechanism 22. The hydraulic pressure generated by the oil pump 21 is supplied to K0 clutch 14, the torque converter 18, the automatic transmission 19, and LU clutch 20 via the hydraulic control mechanism 22. The hydraulic control mechanism 22 is provided with hydraulic circuits of K0 clutch 14, the torque converter 18, the automatic transmission 19, and LU clutch 20, and various hydraulic control valves for controlling the hydraulic pressures.

Hybrid electric vehicle 1 is provided with ECU (Electronic Control Unit) 50 as a control device of the same hybrid electric vehicle. ECU 50 is an electronic control unit including an arithmetic processing unit that performs various arithmetic processing related to travel control of vehicles, and a memory that stores control programs and data. ECU 50 is an exemplary control device and functionally realizes a determination unit, a setting unit, and a control unit, which will be described later in detail.

An ignition switch 61, a crank angle sensor 62, an air flow meter 63, a shift position sensor 64, and a vehicle speed sensor 65 are connected to ECU 50. A water temperature sensor 66, a SOC (State Of Charge) sensor 67, a battery temperature sensor 68, and an accelerator operation amount sensor 69 are connected to ECU 50. The ignition switch 61 detects ON/OFF of the ignition. The crank angle sensor 62 detects the rotation speed of the crankshaft of the engine 10. The air flow meter 63 detects an amount of intake air introduced into the engine 10. The shift position sensor 64 detects whether the position of the shift lever is a P range position, an R range position, an N range position, or a D range position. The vehicle speed sensor 65 detects the traveling speed of hybrid electric vehicle 1. The water temperature sensor 66 detects the temperature of the coolant for cooling the engine 10. SOC sensor 67 detects the charge of the battery 16. The battery temperature sensor 68 detects the temperature of the battery 16. The accelerator operation amount sensor 69 detects an accelerator operation amount that is an opening degree of an accelerator pedal operated by a driver.

ECU 50 controls driving of the engine 10 and the motor 15. Specifically, ECU 50 controls the inverter 17 to control the torque of the motor 15 by adjusting the amount of transfer of electric power between the motor 15 and the battery 16. ECU 50 controls driving of K0 clutch 14, LU clutch 20, and the automatic transmission 19 through control of the hydraulic control mechanism 22.

ECU 50 causes hybrid electric vehicle 1 to travel in either the motor running mode or the hybrid running mode. In the motor running mode, ECU 50 releases K0 clutch 14 to rotate the drive wheels 13 with the power of the motor 15. In the hybrid-mode, ECU 50 engages K0 clutch 14 to rotate the drive wheels 13 with at least the power of the engine 10. For example, when the required driving force for hybrid electric vehicle 1 is equal to or higher than the driving force threshold value, the driving force is switched from the motor driving mode to the hybrid driving mode. Further, when the charge amount of the battery 16 becomes equal to or less than the electric power threshold value, the mode is switched from the motor running mode to the hybrid running mode.

In the hybrid driving mode, ECU 50 increases the negative torque of the motor 15 as the requested charging power of the battery 16 increases. Therefore, for example, when the requested charging power increases in the idle operation state of the engine 10, the negative torque of the motor 15 increases. Therefore, the rotational torque of the input shaft of the torque converter 18 may change from the positive torque to the negative torque, and the gear backlash may increase the rattling noise. In order to suppress such rattle, ECU 50 increases the target idle speed of the engine 10. This is because the centrifugal force caused by the rotation of the input shaft of the torque converter 18 is increased by increasing the target idle speed, and the above-described tooth rattle can be suppressed. ECU 50 controls the idle speed of the engine 10 to be the target idle speed set based on such a viewpoint as follows.

### Idle Speed Control

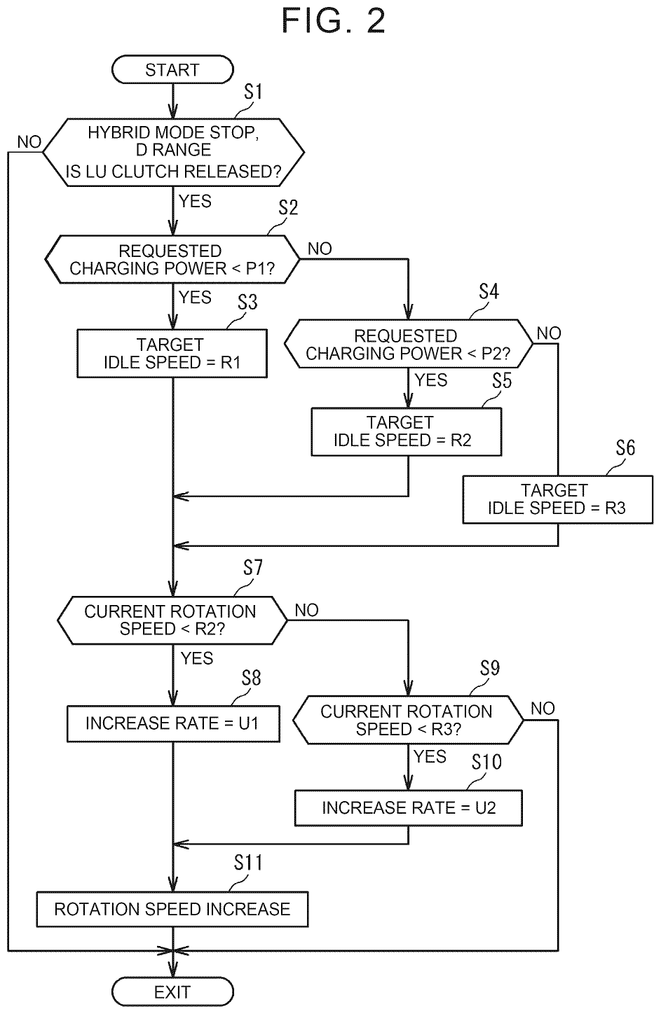

FIG. 2 is a flowchart illustrating idle speed control. This control is repeatedly executed while the ignition is on. ECU 50 determines whether or not hybrid electric vehicle 1 is in the stopped state, the automatic transmission 19 is in the D range, and LU clutch 20 is in the released state (S1). If S1 is No, this control ends. S1 is an exemplary process executed by the determination unit.

If S1 is Yes, ECU 50 determines whether the requested charging power of the battery 16 is less than the first threshold value P1 (S2). If S2 is Yes, ECU 50 sets the target idle speed to the first rotation speed R1 (S3).

If S2 is No, ECU 50 determines whether the requested charging power is less than the second threshold value P2 (S4). The second threshold value P2 is greater than the first threshold value P1. If S4 is Yes, ECU 50 sets the target idle speed to the second rotation speed R2 (S5). The second rotation speed R2 is higher than the first rotation speed R1. If S4 is No, ECU 50 sets the target idle speed to the third rotation speed R3 (S6). The third rotation speed R3 is higher than the second rotation speed R2. S2 to S6 is an exemplary process executed by the setting unit.

After executing S3, S5 or S6, ECU 50 determines whether the present engine speed is less than the second rotation speed R2 (S7). If S7 is Yes, ECU 50 sets the rate of increase of the engine speed to the first rate U1 (S8). The increase rate of the engine speed is an increase amount of the engine speed per unit time.

If S7 is No, ECU 50 determines whether the present engine speed is less than the third rotation speed R3 (S9). If S9 is Yes, ECU 50 sets the rate of increase of the engine speed to the second rate U2 (S10). The second rate U2 is lower than the first rate U1. If S9 is No, this control ends. In this case, the target idle speed is set to the third rotation speed R3, and the engine speed is maintained at the third rotation speed R3.

After performing S8 or S10, ECU 50 controls the engine 10 to increase the engine speed at a set rate of increase (S11). Specifically, the engine speed is increased at a desired increase rate by adjusting the intake air amount, the fuel injection amount, and the ignition timing of the engine 10. S7 to S11 is an exemplary process executed by the control unit.

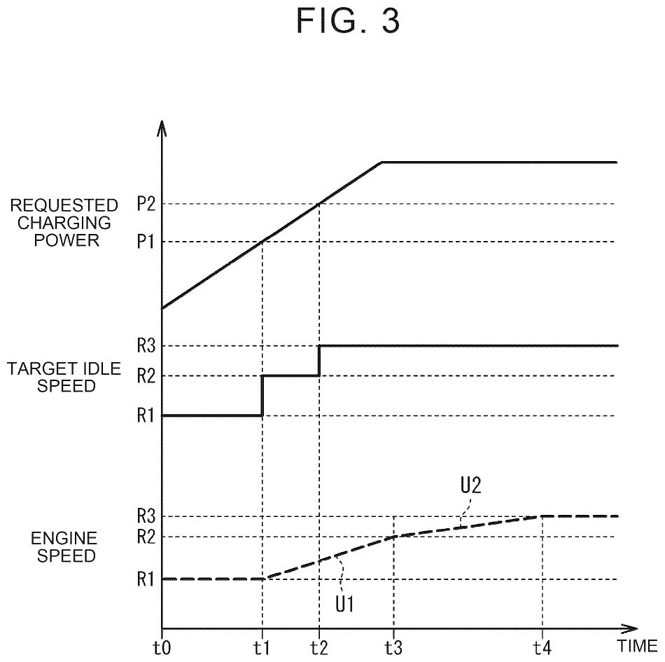

FIG. 3 is a timing chart illustrating idle speed control. FIG. 3 shows changes in requested charging power [kW], target idle speed [rpm], and engine speed [rpm]. FIG. 3 illustrates a case where the requested charging power gradually increases. The requested charging power is less than the first threshold value P1, the target idle speed is set to the first rotation speed R1, and the requested charging power increases from the condition where the engine speed is the first rotation speed R1 (time t0). When the requested charging power becomes equal to or higher than the first threshold value P1, the target idle speed is set to the second rotation speed R2, and the engine speed starts to increase at the first rate U1 (time t1).

When the requested charging power becomes equal to or higher than the second threshold value P2, the target idle speed is set to the third rotation speed R3, but since the engine speed is less than the second rotation speed R2, the increase continues at the first rate U1 (time t2). When the engine speed becomes equal to or higher than the second rotation speed R2, the engine speed starts to increase at the second rate U2 (time t3). When the engine speed becomes equal to or higher than the third rotation speed R3, the increase in the engine speed is stopped and maintained at the third rotation speed R3 (time t4).

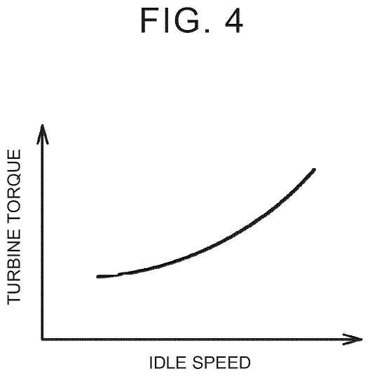

As described above, the engine 10 is controlled such that the higher the engine speed, the lower the increase rate of the engine speed. The reason for this will be described below. FIG. 4 is a graph showing the relation between idle speed [rpm] and turbine torque [Nm]. The turbine torque is the output torque of the turbine shaft 18a, in other words, the torque of the output shaft of the torque converter 18. As shown in FIG. 4, the inclination of the turbine torque increases as the idle speed increases. That is, the higher the idle speed, the higher the rate of increase of the turbine torque. Therefore, the higher the idle speed, the higher the acceleration at the time of starting due to the turbine torque, which may deteriorate the drivability. Therefore, as shown in FIGS. 2 and 3, the higher the engine speed, the lower the rate of increase in the engine speed, thereby reducing the amount of increase in the turbine torque per unit time. As a result, acceleration at the time of starting is suppressed, and a decrease in drivability is suppressed.

As shown in FIGS. 2 and 3, the larger the requested charging power is, the higher the target idle speed is set to a stepwise higher value, and the higher the engine speed is, the lower the increase rate is stepwise, but is not limited thereto. The higher the requested charging power, the higher the target idle speed may be set continuously, and the higher the engine speed may be, the lower the increase rate may be continuously. Further, as shown in FIGS. 2 and 3, the target idle speed is set in three stages, the increase rate is set in two stages, the number of stages may be more.

Although the embodiments of the present disclosure have been described in detail above, the present disclosure is not limited to such specific embodiments, and various modifications and changes can be made within the scope of the gist of the present disclosure described in the claims.

What is claimed is:

1. A hybrid electric vehicle comprising:
an engine;
a motor provided on a power transmission path between the engine and a drive wheel and configured to generate electric power by receiving rotational power of the engine;
a torque converter provided on the power transmission path between the motor and the drive wheel and including a lock-up clutch;
an automatic transmission provided between the torque converter and the drive wheel;
a battery to be charged with generated electric power of the motor; and
a control device, wherein
the control device includes:
a determination unit configured to determine whether the engine is in a driven state, the hybrid electric vehicle is in a stopped state, the automatic transmission is in a D range, and the lock-up clutch is in a released state;
a setting unit configured to, when affirmative determination is made by the determination unit, set a target idle speed that is a target rotation speed in an idle operation state of the engine to a higher value as requested charging power of the battery increases; and
a control unit configured to, when the engine is in the idle operation state, control the engine to reduce an increase rate for increasing an engine speed toward the target idle speed as the engine speed increases.

2. The hybrid electric vehicle according to claim 1, wherein:
the setting unit is configured to set the target idle speed stepwise to a higher value as the requested charging power of the battery increases; and
the control unit is configured to reduce the increase rate stepwise as the engine speed increases.

3. The hybrid electric vehicle according to claim 2, wherein:
the setting unit is configured to set the target idle speed to a first rotation speed when the requested charging power is less than a first threshold value, set the target idle speed to a second rotation speed higher than the first rotation speed when the requested charging power is equal to or more than the first threshold value and less than a second threshold value more than the first threshold value, and set the target idle speed to a third rotation speed higher than the second rotation speed when the requested charging power is equal to or more than the second threshold value; and
the control unit is configured to control the increase rate to a first rate when the target idle speed is set to the second rotation speed or the third rotation speed and the engine speed is less than the second rotation speed, and control the increase rate to a second rate less than the first rate when the target idle speed is set to the third rotation speed and the engine speed is equal to or more than the second rotation speed and less than the third rotation speed.
